(19) United States
(12) Patent Application Publication
(10) Pub. No.: US 2008/0201399 A1
(43) Pub. Date: Aug. 21, 2008

(54) Apparatus And System For Location Assistance And Providing Other Information

(76) Inventor: Zafrir Kariv, Berkeley, CA (US)

Correspondence Address: LATHROP & GAGE LC, 2345 GRAND AVENUE, SUITE 2800, KANSAS CITY, MO, 64108, US

(21) Appl. No.: 12/015,978

(22) Filed: Jan. 17, 2008

Related U.S. Application Data
(60) Provisional application No. 60/885,752, filed on Jan. 19, 2007.

(51) Int. Cl. G06F 15/16

(52) U.S. Cl. 709/201

(57) ABSTRACT

There is provided an interactive system of an apparatus, possessed by a user, and one or more servers or other computer type devices, for providing information to the apparatus over Local and Wide Area, Public, Cellular networks and other networks. The information may be based on location of the apparatus, as received from a Global positioning system or as data therefrom, or may be information provided based on data received from the apparatus, that was inputted by a user of the apparatus.

### CROSS-REFERENCES TO RELATED APPLICATIONS

This application is related to and claims priority from commonly owned U.S. Provisional Patent Application Ser. No. 60/885,752, entitled: Apparatus and System for Location Assistance and Providing Other Information, filed Jan. 19, 2007, the disclosure of which is incorporated by reference herein.

### TECHNICAL FIELD

The disclosed subject matter is directed to apparatus and systems for using the apparatus to assist users with directions, locations, translations, and is operable in voice, text or tactilely.

### BACKGROUND

When people enter a new city of location, they are typically unfamiliar with the city and the area. Additionally, they may not speak the language spoken in that city, or may not have confidence speaking the language there. This may limit their opportunity to enjoy the city. Although there are devices like Blackberry® and Palm® communication devices, cellular telephones and handheld personal global positioning system (GPS) units, none of these devices suit the needs of tourists, seeking to maximize their travel experience in a new city.

### SUMMARY

The disclosed subject matter is directed to a system and an apparatus, for use as part of the system, that allows a tourist or other visitor in an unfamiliar city, information and interaction with the system, with their desired language or any other communication system, in order to maximize their time in that location.

The disclosed subject matter also provides an interactive system of an apparatus, possessed by a user, and one or more servers or other computer type devices, for providing information to the apparatus over Local and Wide Area, Public, Cellular networks and other networks. The information may be based on location of the apparatus, as received from a Global Positioning System (GPS) or as data therefrom, or may be information provided based on data received from the apparatus, that was inputted by a user of the apparatus.

The disclosed subject matter includes an interactive system for providing information. The system includes a Global Positioning System (GPS) in electronic communication with an apparatus possessed by a user of the system, as well as the remainder of the system. The system includes an interface to a network, for example, a Local Area Network (LAN), a Wide Area Network (WAN), typically the Internet, or both, from which information is obtained, computer structure, such as one or more servers for sending data to the apparatus, the data obtained from the network, and computer structure, such as one or more servers for receiving data from the apparatus. There is at least one processor, typically part of a server, computer, or the like, electronically linked to the interface of the global positioning system, the network interface, and the data sending and data receiving means. The processor is programmed to provide information to the apparatus that is obtained from the network that is coordinated with the position of the apparatus of the user, as obtained from the GPS, and provide information to the apparatus, that was obtained that from the network in response to input from the user, sent from the apparatus that received the input. The system is such that the data sent to the apparatus is transmitted by the apparatus in either voice, text, tactilely, or combinations thereof, and the data received from the apparatus was inputted into the system (the requisite server of the system), as voice, text, via a keyboard or touch screen, tactilely, or combinations thereof.

### BRIEF DESCRIPTION OF THE DRAWINGS

Attention is now directed to the drawing figures, where like or corresponding numerals indicate like or corresponding components. In the drawings:

FIGS. 1A and 1B are diagrams of the system of the disclosed subject matter in exemplary uses;

FIG. 2A is a block diagram of the hand held apparatus retained by a user when using the system of FIG. 1;

FIG. 2B is a front view of the handheld apparatus;

FIG. 3 is a view of an example operation of the handheld apparatus showing a screen display;

FIG. 4 is a diagram of another use of the system of FIG. 1;

FIG. 5 is a diagram of a use of the system based on the diagram of FIG. 4; and,

FIG. 6 is a diagram of a use of the system based on the diagram of FIG. 5.

Appendix A—System Specification And Requirements (four sheets) is appended to this document and follows the Claims.

### DETAILED DESCRIPTION OF THE DRAWINGS

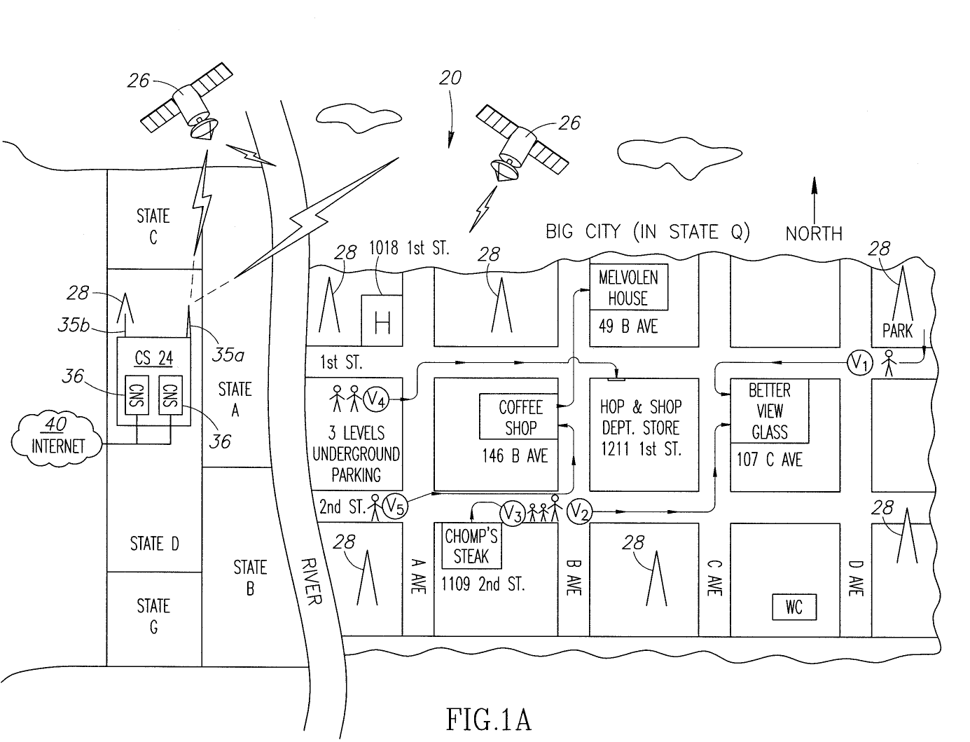

FIGS. 1A and 1B show an exemplary system 20 of the disclosed subject matter from both a regional view, in FIG. 1A, to a local view, in FIG. 1B. The system 20 includes a communication system, that supports communications, typically wireless communications, between handheld apparatus 22 (carried by a user V1-V5) and a central station 24. The central station (CS) 24 is typically located remotely from the location of the users V1-V5. Communication between the apparatus 22 and the central station (CS) 24, is over a satellite network, for example, forming a part of a global positioning system (GPS), formed by satellites 26, a well as over a wireless network, formed by cellular towers 28, as well as any other wireless system working in an enclosed space.

The system 20 is such that, as detailed below, the users, for example, in a city, such as Big City in State Q, and represented, for example, by exemplary users V1-V5, can access their location, directions, translations, telephone numbers and addresses, the Internet 40 and the like, from their location. These various functionalities are detailed below. The Central Station (CS) 24, for example, supports GPS and other communications technologies, and includes a GPS/Satellite/Wireless antenna(s) 35a for receiving such signals, as well as telephone lines/cables 35b, and the like. The antenna(s) 35a and telephone lines/cables 35b are electronically linked to central servers (CNS) 36, and the like, for access to networks, such as the Internet 40. The central station (CS) 24 is typically remotely located, and may be, for example, in a different state, from the state where the user V1-V5 (State Q), is using his apparatus 22, such as in State D.

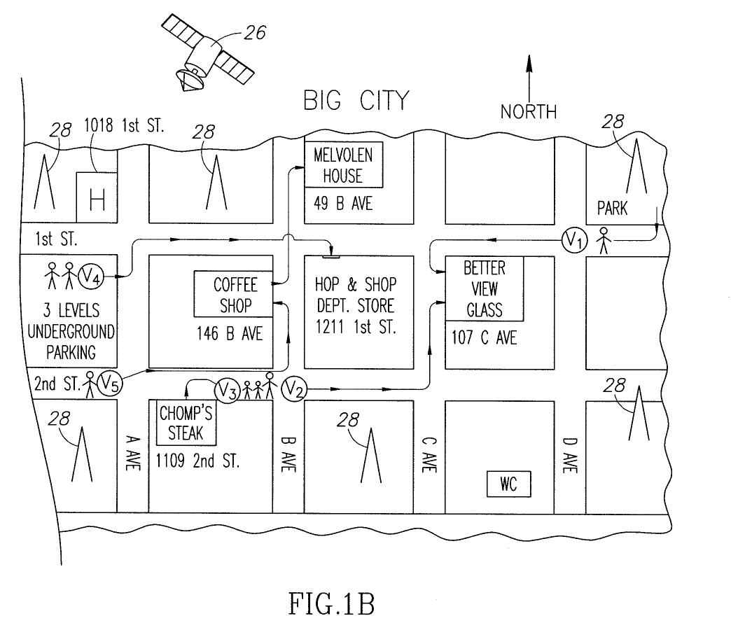

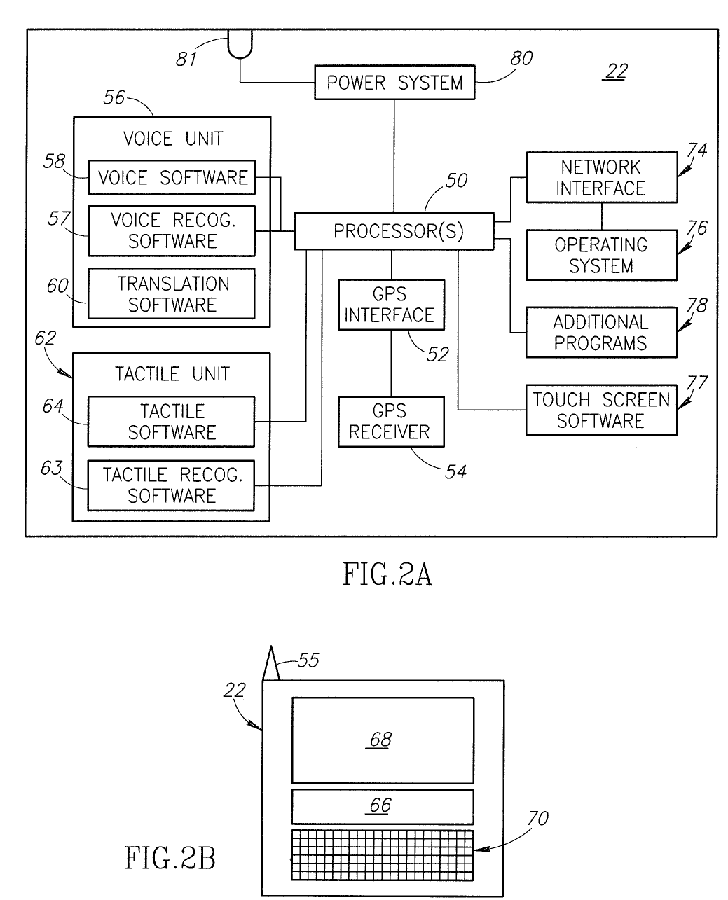

Attention is now directed to FIG. 2A, which shows the handheld apparatus 22. This apparatus 22 includes one or more processors 50, for example a Pentium® processor, that is electrically coupled with various components for performing various functions. Although various components are listed, the components and their functions are exemplary only, and the apparatus 22 can be easily adapted for other components and functions. Moreover, while the various components are shown coupled to the processor 50, they are also in communication with any other component, for proper operation of the apparatus 22.

The apparatus 22 includes a GPS interface 52 coupled with the processor 50, and a GPS Receiver 54, for receiving communications from the GPS Satellites 26. The GPS receiver 54 is also coupled to the antenna 55 (FIG. 2B). The antenna 55 is configured for GPS, cellular, Bluetooth®, or other signals. The information from the GPS interface 52, as well as other text, in numerous languages, or any other wireless signals, may be displayed on the screen 68 of the apparatus 22. The GPS interface 52 and receiver 54 function by continuously tracking the movement of the apparatus 22 (for example, polling the apparatus 22). This information is processed in the central station 24 and sent back to the apparatus 22, typically via the cellular towers 28.

The processor 50 is coupled to a voice unit 56, that includes voice recognition software 57, for example, the software packages entitled: Dragon® Naturally Speaking and, I Command, both by Nuance of Burlington, Mass., and Via Voice by IBM, and voice software 58, such as Read Aloud™, by NextUp.com of Clemmons north Carolina, or Read Please®, from Read Please Corporation of Thunder Bay, Ontario, Canada, by to return information to the user in a spoken voice. There is also translation software 60, such as Systran® from Systran Software of San Diego, Calif., that is accessible by the voice unit 56 through the processor 52.

Similar to the voice unit 56, there is a tactile unit 62. This tactile unit 62 is formed of tactile recognition software 63 and tactile software 64, such as Transnote from IBM, Cybertouch from Cybertouch of Newberry Park, Calif., and The I Pen from Finger System, Inc. of Seoul, South Korea, to send information to the user in various tactilities. The tactile sending and receiving portion of the apparatus includes a tactile area 66 on the apparatus, between the screen 68 and the keyboard 70, as shown in FIG. 2B.

The processor 50 is coupled to a network interface 74 and operating system 76, for example Windows®, from Microsoft. This network interface 74 (coupled to the antenna 55 of FIG. 2B) and the operating system 76 allow for access to networks, such as the Internet 40, with Internet images displayed on the screen 68, including hypertext links and the like. The screen 68, for example, may also be a touch screen, activated by touch, typically with a stylus, but also manually, with, for example, a human finger. The touch screen control and logistics are controlled by the touch screen software 77 in the apparatus 22.

The processor 50 is also coupled to a component 78, labeled “additional programs” to support added programs. The apparatus 22 includes all of the requisite hardware and software to support adding programs, updating the existing programs, and deleting programs, as necessary. For example, the apparatus 22 is suitable for linking to a personal computer or the like, for updating and adding programs, and deleting programs as necessary, as well as linking to other apparatus 22, cell phones, I-pods®, personal digital assistants (PDAs), digital imaging devices, and the like.

The apparatus 22 also includes a power system 80. The power system 80 provides power to the aforementioned components and the processor 50. It typically receives power from an electrical outlet, automobile outlet, or power pack, similar to that for an automobile, through a port 81. The power system 80 can also receive power from a built-in or outboard photocell, to charge its batteries or power source.

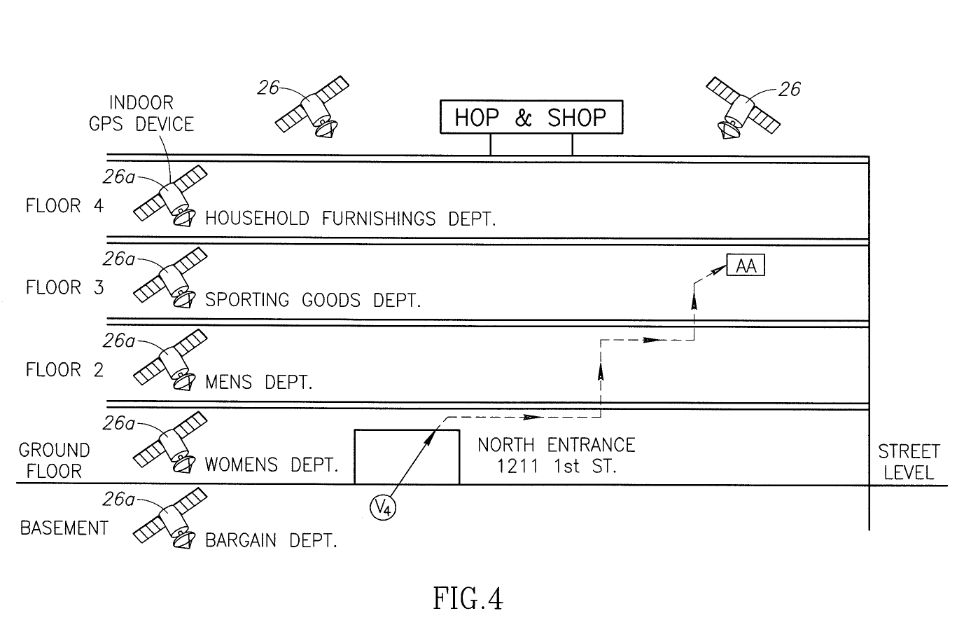

The GPS used with the apparatus 22 operates both horizontally and vertically. By “horizontal”, it is meant that directions on a common surface level are provided, for example, street or ground level. This “horizontal” aspect of the GPS is typically for maps and directions on a street or ground level outside of structures, as shown by the GPS satellites 26. The “vertical” aspect of the GPS, is that it can be positioned on various levels of a structure, and provides maps and directions between the various levels, as illustrated by the GPS devices 26a (FIGS. 4-6). These GPS devices 26a may also be used for “horizontal” directions inside structures.

The apparatus 22 also interacts with the Central Station (CS) 24, that, for example, serves as both a portal to a wide area network, such as the Internet 40, and a data bank (in various computers, servers and the like in the central station (CS) 24, where specific information, is stored. This specific information may be addresses and telephone numbers, restaurant lists for types of restaurants, restaurant reviews, directions to public washrooms, telephones, automatic teller machines, and the like. For example, within the computers of the central station (CS) 24, a user's location (of the apparatus 22) is tracked by the GPS (with the location of the apparatus 22 reported to the central station (CS) 24 by the GPS), and comparison software and the like finds locations, telephone numbers of businesses and the like, from a network, such as the Internet or database (in one of the aforementioned computers), proximate to the user's location. It then provides the apparatus 22 with information on the selected businesses.

For each user with an apparatus 22, the servers, for example, the central server(s) (CNS) 36 in the Central Station (CS) 24 tracks information sought and stores information or links thereto. The central station (CS) 24 includes numerous computers, servers and the like, including the central server(s) (CNS) 36 that include databases for storing information, system users, and the like, and software and hardware for operating the system 20. Based on the information stored, the central station (CS) 24 executes a program to find related locations or events a user may like, or that are in accordance with predetermined preferences entered into the apparatus 22 by the user, that are in the proximity of the user.

Each of the central servers (CNS) 36 is also capable of extracting other related information via satellites, internet services, ground antennas or other free or for-pay communication systems (such as news, weather updates, traffic flow or urban traffic system or a restaurant's menu) and transmits any and all of this information via the cellular system (shown by the cellular towers 28), to the apparatus 22. Each central server (CNS) 36 is also suited for computing and computer-type functions, and may also be linked to a computer or the like (within or outside of the central station (CS) 24).

The apparatus 22 may also be programmed for user preferences, for example by storing requests for food stores, art galleries, movie theatres and the like. For example, should the user be taking a trip to New York City, they can program their apparatus 22 to search for coffee shops, something they do not have programmed onto their apparatus 22 when they are using it locally, as part of their daily life. The users may activate this coffee shop searching application when desired.

Keeping with the example of the coffee houses in New York City, the user, on an initial route, seeks to make a mid trip change by activating the coffee shop searching application, and the CNS 36 provides the apparatus 22 with four locations where to have coffee in both voice and text, as an on-screen display in the apparatus 22. The four coffee houses were obtained by the system 20 estimating the user's time to travel to each coffee shop, based on the average speed movement of the user (holding the apparatus 22) in the last hour, and the hours of operation for each coffee shop.

Once this side-trip for coffee houses is finished, the user gives (enters) a command to the apparatus 22 (voice or data entry), such that the apparatus reverts to its original operation with any necessary adjustments. Since the user's speed has now been established by the CNS 36, the CNS 36 adjusts to the change in position and location, as well as any user changes, for example, stopping at another location, prior to again resuming the initial activity.

The requirements of the apparatus 22 as part of the system 20 are listed in Appendix A—System Specification and Requirements.

Exemplary operations of the system 20 are now detailed in Examples 1-5, with Examples 1-4 making reference to FIGS. 1A, 1B, 3 and 4-6.

### EXAMPLE 1

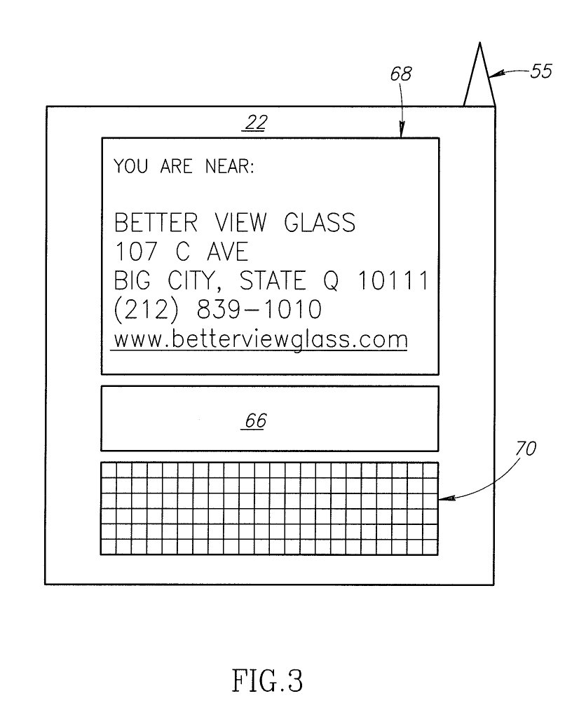

Mrs. T (V1), a tourist in Big City and native Japanese speaker has finished her jog in the park, at First Street and D Avenue. As she walks along First Street, back to her hotel (H) at First Street and A Avenue (1018 First Street, FIGS. 1A and 1B), she checks her apparatus 22. On her screen display 68, there is indicted the Better View Glass Store at 107 C Avenue (FIGS. 1A and 1B), with its telephone number, and link to its web site, in her general area, in accordance with the screen shot of FIG. 3. Mrs. T had previously programmed her apparatus to indicate points of interest in Big City, including specialty stores, such as glass stores. Mrs. T (V1) now obtains directions including a map of her route from her location, through her apparatus 22, and travels to the Better View Glass Store.

### EXAMPLE 2

Mr. T (V2) and his children T₁ and T₂ (collectively V3) are leaving Chomp's (a steak house that the system had found for them earlier), at 1109 2^{nd} Street. They use the GPS of the system 20 to travel to the Better View Glass Store at 107 C Avenue, to meet Mrs. T. Both apparatus 22 of Mr. T (V2) and Mrs. T (V1) will provide an estimate of the time required to travel for each user (person) to the Better View Glass Store.

While at the Better View Glass store, Mr. T realizes that he did not leave a sufficient gratuity for the waitress at Chomp's. He activates his apparatus 22 to add the amount showing his credit card bill and charge it to his credit card. The apparatus 22, accesses the central server(s) (CNS) 36, provides access to Chomp's web site, where Mr. T completes the requisite transaction, here, adding the extra gratuity amount, by charging it to his credit card.

### EXAMPLE 3

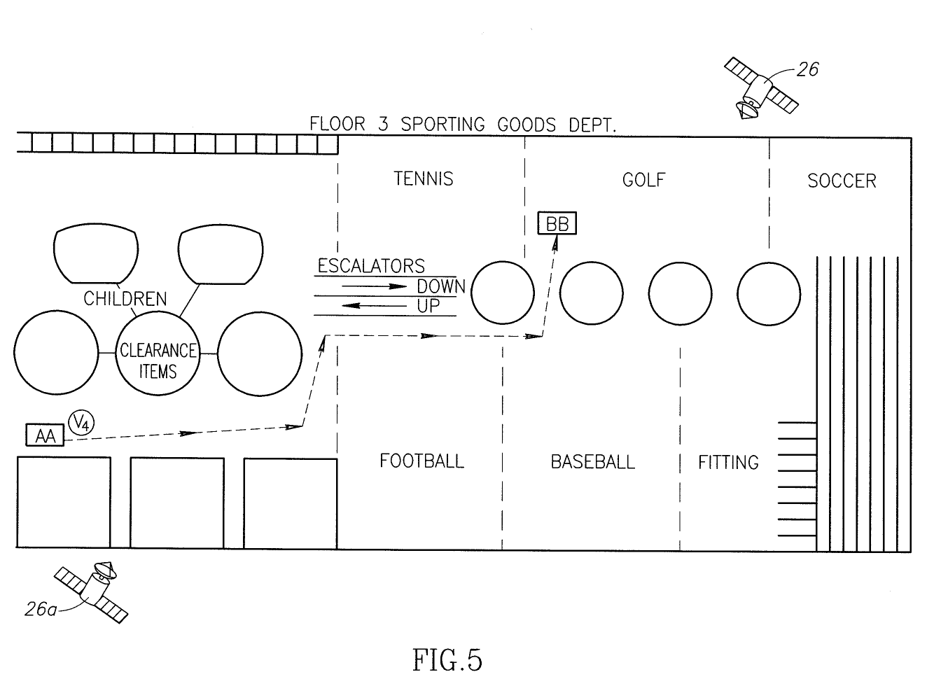

Ms. & Mrs. P (V4), who only recently moved to Big City from France, head to Hop & Shop Department Store, as they want to look at golf equipment. They are directed by the GPS functionality of their apparatus 22, from Level 2 of the Underground Parking Garage at First Street and A Avenue, to the Hop & Shop Department Store, at First Street and B Avenue. Specifically, they are directed by the apparatus 22 to the North Entrance of the Hop & Shop Department Store, at 1211 1st Street. Once they enter the Hop & Shop Department Store, they are on the Ground Floor (on the street level), as shown in FIG. 4. They enter their request into their apparatus 22, to be directed to the golf section of the sporting goods department. Based on information received through the indoor GPS devices 26a, they are directed “vertically” to the third floor, the location of the sporting goods department, and are now at location AA, as shown in FIGS. 4 and 5.

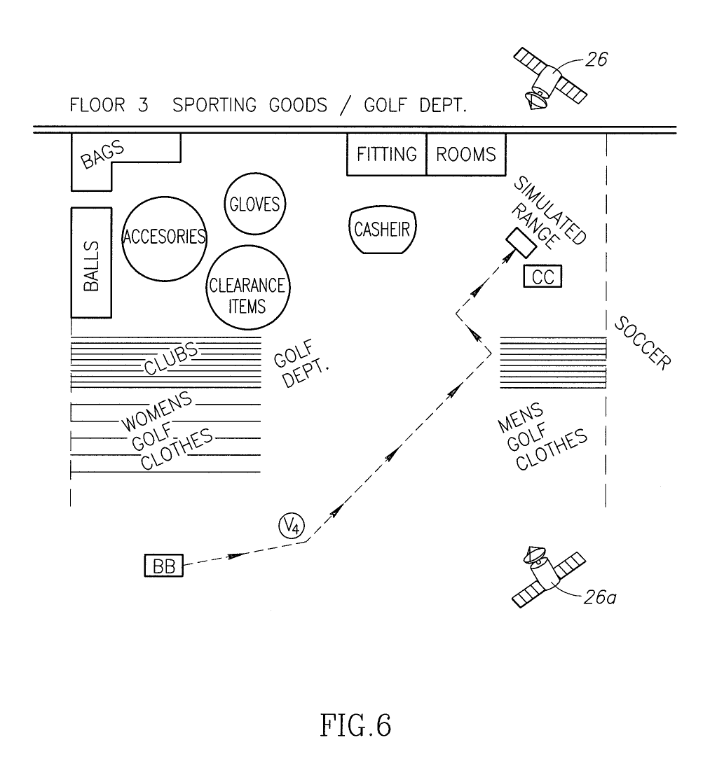

Using the apparatus 22, they are further directed “horizontally” to the golf section within the sporting goods department, and to location BB, as shown in FIGS. 5 and 6. Viewing their map of the golf section of the sporting goods department, that appears on the screen 68 of the apparatus 22, they see the Simulated Range, where they want to try some golf clubs. Following the map, they walk from location BB to the simulated range, at location CC, as shown in FIG. 6.

### EXAMPLE 4

Dr. Z, V5, attending a history conference at the local university is to meet one of his former students at the Coffee Shop on 146 B Ave. Dr. Z is directed by his apparatus 22, from the corner of A Avenue and Second Street to the Coffee Shop at 146 B Avenue. From there they will visit Melvolen House—a 17th century Museum of Russian emigrants who settled in Big City and State Q, located at 49 B Avenue. Using the apparatus 22 they will be provided with directions from the Coffee Shop to Melvolen House, at 49 B Avenue.

They may also use the apparatus 22, to provide them with information about the Melvolen House, such as a detailed historical, cultural, political and economical explanation these settlers, by accessing a web site in Russian. They may also use the apparatus 22 to obtain the web site of the Melvolen House, to obtain a map of the exhibits, with descriptions and explanations of the items in each exhibit.

### EXAMPLE 5

An Algorithm for the system 20 and apparatus 22

Part 1
Symbols:
TWAH=The World At Hand—the apparatus 22
WCB=a Wireless Communication Base-Cellular Towers 28
CNS=Central Server(s) 36
=>=Input to TWAH
<=>=Output from TWAH
>>>=Communication from TWAH=>WCB==>CNS
<<<=Communication from CNS==>WCB==>TWAH=
̂̂̂=Extracting information from data base or from other available sources
**=asking for further instructions

Part 2

Mr. Tourist (Mr. Y), his wife (Mrs. Y) and two children, a nine year old boy (YB) and twelve year old girl (YG), all native Japanese speakers, are visiting New York City for the first time. The Family speaks very basic English, and lacks the confidence to speak it publicly, except in cases of emergency. They rely on their TWAH apparatus, as a directional and virtual guide.

Before leaving Japan, the Y family pre-loaded their apparatus 22 with Japanese Speech Recognition software, Japanese-English and English-Japanese translators and dictionary software, downloads similar to that for a Personal Digital Assistant (PDA), Cell Phone I-pod® or the like.

Today, while walking on 6th Avenue toward the Empire State Building, Mr. Y wants stop for tea. Mr. Y enters the following voice command into his apparatus:
=>I want to drink a Phora tea (in Japanese)
>>>TWAH ==>WCB ==>CNS
̂̂̂CNS (it search its data base in Japanese and English)
<<<CNS ==>WCB ==>TWAH
<=>There are 12 locations within 1.6 kilometers (KM) (1.6 KM=1 mile). The first two locations have the specific tea and a menu, with the specific teas and the tea menu at the other ten locations not known, as this information is not available to the system 20 (Voice response and on-screen display in Japanese). The twelve locations are displayed on the screen 68 of the apparatus 22, in an order in accordance with Mr. Y's preprogrammed preferences.
**The user is prompted to select one of the listed twelve locations, in either touch screen, data entry or voice mode—Which one you choose?
=>Show me the first (Mr. Y's voice command in Japanese)
<=>(Voice response and on-screen display in Japanese): “Café Hajin is 10 minutes away by foot and three minutes away by car, its address is 2345 Park Avenue, its business hours are 10 am to 11 pm, its menu is (includes prices) accessible at www.cafehajin.com/menu, and “Reservations are not required.” The voice response also notes that “It is customary to leave 15% tip for waiter(s), the telephone number is: 212-354-9999, and its web site is www.cafehajin.com.”
**The user is prompted again by a voice prompt: “Would you like to see its web site?”
=>No. I would like direction directions (Mr. Y's voice command in Japanese)
<=>(Voice response and on-screen display in Japanese): “There are three options from your present location on 6^{th} Avenue to Café Hajin:
a) The shortest route
b) A small site-seeing route, or
c) The easiest route for wheelchairs, elderly or families with small children.”
=>Show me the small site-seeing route (Voice command from Mr. Y in Japanese)
<=>(The TWAH apparatus provides a voice response and on-screen display in Japanese the information that was downloaded to it): It provides voice and on-screen display directions how to proceed, and, for example, architectural aspects of the building or structure they are proximate to, the history and historical significance, its political/cultural or economic importance (current or past). There is also voice and an on-screen display in Japanese for otherfacts (height, year built, stories and major occupants if any) about this structure.
=>What kind of material used for its fa§ade? (Voice command from Mrs. Y in Japanese)
>>>; ̂̂̂; <<<;
<=>Limestone imported from Mexico (a voice response and on-screen display in Japanese).

The family continues to travel, and receives a voice and display prompt, that there is a car on fire along their site seeing route.
<=>There is a car on fire in your path to Café Hajin, would you like to change it?
**
=>Yes
>>>; ̂̂̂; <<<;
<=>(New directions are provided in voice and in an on-screen display, in Japanese)

The Y family has now reached Café Hajin, and is now seated ready to order their tea. The waiter speaks only English.
=>Tea for all four of us—Translate to English (voice command from Mr. Y in Japanese).
<=>Tea for four (voice response in English)

The waiter now provides each member of the Y family with a menu. They select additional food items. They activate the apparatus 22, that displays the menu in Japanese, as follows:
=>Menu Please (voice command from Mr. Y in Japanese)
>>>, ̂̂̂, <<<
<=>menu

The menu is also displayed in English with the menu selections visible to the waiter, who is now able to take the order.

While waiting for their food order to arrive, Mr. Y provides the apparatus with a voice command for News from Yokohama, Japan:
=>News from Yokohama (Voice command in Japanese)
<=>Live or recorded? (Voice and on-screen display prompt, in Japanese)
=>Live (Voice response of Mrs. Y in Japanese).
>>>TWAH==>WCB==>CNS
̂̂̂ (looking into data base and other sources of information)
<<<
<=>Live news on channels four and seven. Any preference? (Voice and on-screen display prompt, in Japanese)
=>Channel seven (Voice response of Mrs. Y in Japanese)
<=>News on channel seven from Yokohama is spoken and displayed (with Japanese language captioning) in an on-screen display on the TWAH apparatus.

After 10 minutes, Mrs. Y provides a voice command to the apparatus, to switch to children programs:
=>Children's TV please (Voice command of Mrs. Y in Japanese)
<=>TV or cable? (Voice and on-screen display prompt, in Japanese)
=>Cable (Voice response of Mrs. Y in Japanese)
<=>Six programs are available (Voice and on-screen display prompt of all six available programs, in Japanese)
=>Number three please (Voice response of Mrs. Y in Japanese)
<=>Program three is broadcast and displayed. It is the Y daughter's (YG) favorite show, and it is an interactive broadcast, identical to that received through her conventional interactive television at home. The TWAH apparatus allows for the requisite interaction

With the meal finished, they decided to buy some gifts:
=>Shopping for gifts (Voice command of Mrs. Y, in Japanese)
<<<; ̂̂̂; >>>;
=>There are three department stores nearby: Macy's, The Bon Ton and Big Store (Voice and on-screen display prompt, in Japanese)
=>Macy's (Voice Response from Mrs. Y)

The TWAH apparatus, then provides three options for a route to Macy's from Café Hajin:
<=>a) Shortest route; b) Small sightseeing route; c) easiest route for wheelchairs, elderly and families with small children (Voice and on-screen display prompt, in Japanese)
=>Shortest route (Voice Response from Mrs. Y, in Japanese)

Directions are provided on the on-screen display in Japanese and in 28 minutes (the TWAH apparatus estimated their arrival time) they are standing in front of Macy's.
=>Children's department please (Voice command of Mrs. Y, in Japanese)
<=>Instructions to go through the doors, turn left, go straight. Elevators on your right hand side. Enter elevator and go down two floors (to number one). After existing turn right, go straight, turn left and left again. You are in front of the children department. (Voice response and on-screen response, in Japanese)
=>I am looking for a pair of hiking boots for a nine year old boy—Translate to English (Voice command of Mr. Y in Japanese)
The TWAH apparatus repeats the command in English and it is displayed in both languages. The salesperson responds by bring out a pair of size 4 hiking boots for the Y's nine year old boy (YB).

While the trying on his hiking boots, the Y boy begins to speak with a French speaking boy (FB), whose parents Mr. And Mrs. F, are also shopping for shoes for him. Unable to communicate, Mr. Y issues the following voice command to his TWAH apparatus:
=>French translator (Voice command of Mr. Y in Japanese)
>>>; ̂̂̂; <<<; (the CNS finds the French/Japanese translator and downloads it into Mr. Y's TWAH apparatus, over the cellular network, via the Internet.

Mr. Y then issues a command:
=>Son, please tell your new friend that we have to leave for dinner (Voice command of Mr. Y, in Japanese)

The TWAH apparatus translates Mr. Y's statement from Japanese to French and provides the French translation in a voice and on screen display (text) response in French, understandable by the boy (FB) and his parents Mr. And Mrs. F.

As it is now time for dinner, Mr. Y provides the TWAH apparatus with a voice command:
=>Restaurants please (Voice command of Mr. Y, in Japanese)
<=>Type of food? (Voice and on-screen display prompt in Japanese)
=>Italian (Voice command of Mr. Y, in Japanese)
<=>There are four 3 star rated and five 2 star rated Italian restaurants within 30 minutes of your location (Voice and on-screen display prompt in Japanese)
=>3 stars (Voice command of Mr. Y, in Japanese)
<=>The TWAH says and displays all four (Voice and on-screen display prompt in Japanese)
=>Number two (Voice response of Mr. Y, in Japanese).
<=>The TWAH apparatus provides a voice response and an on-screen display response, with the restaurant's name, its location, telephone number, internet address, the business hours, the menu and prices. In addition, the apparatus 22 provides the Y family with a distance to the restaurant and an estimated time or arrival, based on their present pace, weather conditions, traffic and other road hazards.
=>Reservation? (Voice and on-screen display prompt in Japanese)
<=>Phone number and web-site is displayed (in English), the web site includes an automated reservation system from which Mr. Y uses the keyboard 70 of his apparatus to make a 7 pm reservation for this evening from the restaurant's web site.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments have been described, so as to enable one of skill in the art to practice the disclosed subject matter, the preceding description is intended to be exemplary only. It should not be used to limit the scope of the disclosed subject matter, which should be determined by reference to the following claims.

1. An interactive system for providing information comprising:
an apparatus configured for electronic communication with a Global Positioning System, and receiving input from at least one user; and,
at least one server configured for interfacing with a network from which information is obtained, and for receiving data from a Global Positioning System, the at least one server including:
means for sending data to the apparatus;
means for receiving data from the apparatus; and
at least one processor in electronic communication with a network interface, the data sending means and the data receiving means, the processor programmed to:
provide information to the apparatus that is obtained from a network that is coordinated with the position of the apparatus in accordance with data received from a Global Positioning System; and,
provide information to the apparatus that is obtained from a network in response to received data.

2. The system of claim 1, additionally comprising: means for providing the information to the apparatus in at least one of text in an on-screen display, voice, or tactilely.

3. The system of claim 2, wherein the network includes at least one of a Local Area Network or a Wide Area Network.

4. The system of claim 3, wherein the Local Area Network includes a private network.

5. The system of claim 4, wherein the Wide Area Network includes the Internet.

6. The system of claim 1, wherein the means for sending data includes means for sending data to the apparatus such that the apparatus provides the data in at least one form of at least one of voice, text, or tactilely.

7. The system of claim 1, wherein the means for receiving data includes means for receiving and processing voice, text, the text being entered in words or via a touch screen, or tactilely entered signals.
